(19) United States
(12) Patent Application Publication
(10) Pub. No.: US 2020/0206543 A1
(43) Pub. Date: Jul. 2, 2020

(54) GENERAL-PURPOSE SYNTHETIC RESIN MASK USING VELCRO INSERTING-TYPE FILTER EXCHANGE MODE, AND INJECTION MOLDING DEVICE AND MANUFACTURING METHOD THERFOR

(71) Applicant: IN TECH CO., LTD., Jeonju-si (KR)

(72) Inventor: Chang Sun LEE, Jeongeup-si (KR)

(21) Appl. No.: 16/814,315

(22) Filed: Mar. 10, 2020

Related U.S. Application Data
(62) Division of application No. 15/028,996, filed on Apr. 13, 2016.

(30) Foreign Application Priority Data
Oct. 17, 2013 (KR) 10-2013-0123798

(51) Int. Cl. A62B 18/02; A62B 23/02; A62B 9/04; B29C 45/14; B29C 45/18; B29C 45/26; B29C 45/47

(52) U.S. Cl. CPC A62B 18/02; A62B 23/025; A62B 9/04; B29C 45/14065; B29L 2031/4835; B29C 45/1816; B29C 45/2628; B29C 45/47; B29C 45/14467

(57) ABSTRACT

A velcro inserting type universal synthetic resin mask with a replaceable filter, an injection molding apparatus therefor, and a manufacturing method thereof are described. The velcro inserting type universal synthetic resin mask with a replaceable filter can include a mask guide with a rim-like shape which supports a filter insertion portion therein and is formed of a synthetic resin by an injection molding process using an upper mold and a lower mold along with the filter insertion portion; and a velcro for attachment of a filter which is placed at a front portion of a velcro entity for attachment of a filter forming portion of the upper mold during the injection molding process for the mask guide and the filter insertion portion and formed on the mask guide when inserted such that the velcro for attachment of a filter is fixed through a velcro entity insertion hole of the upper mold.

This application is a divisional of U.S. application Ser. No. 15/028,996 filed on Apr. 13, 2016, which is a national stage application of PCT/KR2014/004743, filed on May 27, 2014, which claims priority to KR10-2013-0123798, filed on Oct. 17, 2013, the disclosure of which is incorporated herein by reference in its entirety.

### FIELD OF THE INVENTION

The present invention relates to a velcro inserting type universal synthetic resin mask with a replaceable filter, an injection molding apparatus therefor, and a manufacturing method thereof and, more specifically, to a velcro inserting type universal synthetic resin mask with a replaceable filter which greatly reduces manufacturing time by using a one-stop injection molding using a mold, and increases a hygiene level by replacing filters, an injection molding apparatus therefor, and a manufacturing method thereof.

### DESCRIPTION OF THE RELATED ART

Conventionally, masks are worn on a face in order to prevent harmful matters generated in a contaminated area, at various emergency situations, in an industrial field where air can be contaminated, etc. from permeating into a human body, or are used to block viruses, etc. from being introduced from outside through respiratory organs.

These masks are normally arranged such that sanitated cotton or fabric serves as a filter during respiration, thereby preventing infiltration of dusts, foreign matters, various germs, etc.

In general, masks which are worn to prevent a direct contact to external air when respiratory diseases such as coughs or influenza, etc. break out or when a wearer works in a place where much dust or bad smell prevails are composed of a rectangular front cover fabric cloth for covering a nose or a mouth of the wearer and connecting laces which are coupled with both sides of the cover fabric and worn on both ears to suspend the cover fabric.

Since the rectangular fabric are worn on both ears according to the conventional mask, the conventional masks are manufactured by forming the rectangular fabric first, forming a holding portion for holding the fabric on both ears separately from the fabric, and attaching the holding portion to the fabric. Therefore, the manufacturing process is complicate which requires long manufacturing time.

Also, the mask manufactured by the conventional method is hard to be reused after being stored, and it has weak filtering function as it simply uses a fabric to perform the filtering. Furthermore, diversity of the manufactured product is relatively weak.

### DOCUMENT OF RELATED ART

1. “REUSABLE FACIAL MASSAGING MASK” (Korea Patent Application No. 10-2004-0000776)

2.“FUNCTIONAL HYGIENE MASK PROTECTING RESPIRATORY ORGANS AND PROTECTING CONTAGIOUS DISEASES” (Korea Patent Application No. 10-2003-0028361)

### DISCLOSURE OF THE INVENTION

### Technical Problem

The present invention is devised to solve the aforementioned problems, and an objective of the present invention is to provide a velcro inserting type universal synthetic resin mask with a replaceable filter which greatly reduces manufacturing time by using a one-stop injection molding using a mold, and increases a hygiene level by replacing filters, an injection molding apparatus therefor, and a manufacturing method thereof.

Also, an objective of the present invention is to provide a velcro inserting type universal synthetic resin mask with a replaceable filter which raises a hygiene level by replacing filters, provides a long-term storage after the filter is removed, and enabling reuse of the filter, an injection molding apparatus therefor, and a manufacturing method thereof.

Also, an objective of the present invention is to provide a velcro inserting type universal synthetic resin mask with a replaceable filter which improves a filtering function by designing a replaceable filter and a filter insertion portion therefor, and which can be manufactured in various shapes, an injection molding apparatus therefor, and a manufacturing method thereof.

However, it should be noted that the objectives of the present invention are not restricted to the aforementioned objects, and other objects which are not mentioned above can be readily understood by a person having ordinary skill in the art from the description as follows.

### Technical Solution

In order to accomplish the aforementioned objectives, the velcro inserting type universal synthetic resin mask with a replaceable filter according to an embodiment of the present invention comprises: a mask guide with a rim-like shape which supports a filter insertion portion therein and is formed of a synthetic resin by an injection molding process using an upper mold and a lower mold along with the filter insertion portion; and a velcro for attachment of a filter which is placed at a front portion of a velcro entity for attachment of a filter forming portion of the upper mold during the injection molding process for the mask guide and the filter insertion portion and formed on the mask guide when inserted such that the velcro for attachment of a filter is fixed through a velcro entity insertion hole of the upper mold.

In order to accomplish the aforementioned objectives, an injection molding apparatus for a velcro inserting type universal synthetic resin mask with a replaceable filter according to an embodiment of the present invention characterized comprises: a lower mold which is engraved to form a lower side of a mask guide which constitutes the velcro inserting type universal synthetic resin mask with a replaceable filter, wherein the lower mold includes a lower mask guide forming portion including four separate velcro entity for attachment of a filter forming portions for placing a velcro for attachment of a filter on a lower surface of the mask guide, wherein the velcro entity for attachment of a filter forming portions are arranged in top-down and bilateral symmetry; and an upper mold which is engraved to form an upper side of the mask guide, wherein the upper mold includes an upper mask guide forming portion including four separate velcro entity insertion hole forming portions for fixing the velcro for attachment of a filter on a lower surface of the mask guide, wherein the velcro entity insertion hole forming portions are arranged in top-down and bilateral symmetry.

In order to accomplish the aforementioned objectives, a method of manufacturing a velcro inserting type universal synthetic resin mask with a replaceable filter according to an embodiment of the present invention comprises: a first step in which lower mold including a velcro entity for attachment of a filter forming portion and an upper mold including a velcro entity insertion hole forming portion are formed; a second step in which inserting of the velcro for attachment of a filter is performed on the velcro entity for attachment of a filter forming portion of the lower mold; a third step in which a synthetic resin for forming a mask guide and a filter insertion portion is stirred and supplied to a hopper; and a fourth step in which a high pressure injection process of the synthetic resin, which is molted in a heating cylinder, is performed between the lower mold and the upper mold by way of a screw such that manufacturing of the velcro inserting type universal synthetic resin mask with a replaceable filter is completed.

### Advantageous Effects

By using the velcro inserting type universal synthetic resin mask with a replaceable filter, the injection molding apparatus therefor, and the manufacturing method thereof according to embodiments of the present invention, the manufacturing time can be greatly reduced by using an one-stop injection molding process using a mold.

Also, by using the velcro inserting type universal synthetic resin mask with a replaceable filter, the injection molding apparatus therefor, and the manufacturing method thereof according to embodiments of the present invention, a hygiene level can be raised by replacing filters and the filter can be stored for a long period of time, which provides an effect of reusing the filter after a long time storage.

Also, by using the velcro inserting type universal synthetic resin mask with a replaceable filter, the injection molding apparatus therefor, and the manufacturing method thereof according to embodiments of the present invention, replaceable filters and a filter insertion portion therefore are designed, which enhances a filtering function and enables the masks to be manufactured in various shapes.

### BRIEF DESCRIPTION OF THE DRAWINGS

FIGS. 1A and 1B are diagram illustrating a velcro inserting type universal synthetic resin mask with a replaceable filter 1a which is formed as a first type according to an embodiment of the present invention.

FIG. 2 is a diagram illustrating a velcro inserting type universal synthetic resin mask with a replaceable filter 1b which is formed as a second type according to an embodiment of the present invention.

FIG. 3 is a diagram illustrating a velcro inserting type universal synthetic resin mask with a replaceable filter 1c which is formed as a third type according to an embodiment of the present invention.

FIG. 4 is a diagram illustrating a velcro inserting type universal synthetic resin mask with a replaceable filter 1d which is formed as a fourth type according to an embodiment of the present invention.

FIG. 5 is a diagram illustrating a velcro inserting type universal synthetic resin mask with a replaceable filter 1e which is formed as a fifth type according to an embodiment of the present invention.

FIG. 6 is a diagram illustrating a velcro inserting type universal synthetic resin mask with a replaceable filter if which is formed as a sixth type according to an embodiment of the present invention.

FIGS. 7 and 8 are diagrams illustrating an injection molding apparatus for the velcro inserting type universal synthetic resin mask with a replaceable filter according to an embodiment of the present invention.

FIG. 9 is a flow chart illustrating a method of manufacturing the velcro inserting type universal synthetic resin mask with a replaceable filter according to an embodiment of the present invention.

FIG. 10 is a diagram illustrating structures of a first stirrer and a second stirrer which are used for manufacturing the velcro inserting type universal synthetic resin mask with a replaceable filter according to an embodiment of the present invention.

### BEST MODE FOR CARRYING OUT THE INVENTION

A velcro inserting type universal synthetic resin mask with a replaceable filter characterized in comprising:

mask guide with a rim-like shape which supports a filter insertion portion therein and is formed of a synthetic resin by an injection molding process using an upper mold and a lower mold along with the filter insertion portion; and

a velcro for attachment of a filter which is placed at a front portion of a velcro entity for attachment of a filter forming portion of the upper mold during the injection molding process for the mask guide and the filter insertion portion and formed on the mask guide when inserted such that the velcro for attachment of a filter is fixed through a velcro entity insertion hole of the upper mold.

An injection molding apparatus for a velcro inserting type universal synthetic resin mask with a replaceable filter characterized in comprising:

a lower mold which is engraved to form a lower side of a mask guide which constitutes the velcro inserting type universal synthetic resin mask with a replaceable filter, wherein the lower mold includes a lower mask guide forming portion including four separate velcro entity for attachment of a filter forming portions for placing a velcro for attachment of a filter on a lower surface of the mask guide, wherein the velcro entity for attachment of a filter forming portions are arranged in top-down and bilateral symmetry; and

an upper mold which is engraved to form an upper side of the mask guide, wherein the upper mold includes an upper mask guide forming portion including four separate velcro entity insertion hole forming portions for fixing the velcro for attachment of a filter on a lower surface of the mask guide, wherein the velcro entity insertion hole forming portions are arranged in top-down and bilateral symmetry.

A method of manufacturing a velcro inserting type universal synthetic resin mask with a replaceable filter is characterized in comprising:

a first step in which lower mold including a velcro entity for attachment of a filter forming portion and an upper mold including a velcro entity insertion hole forming portion are formed;

a second step in which inserting of the velcro for attachment of a filter is performed on the velcro entity for attachment of a filter forming portion of the lower mold;

a third step in which a synthetic resin for forming a mask guide and a filter insertion portion is stirred and supplied to a hopper; and

a fourth step in which a high pressure injection process of the synthetic resin, which is molted in a heating cylinder, is performed between the lower mold and the upper mold by way of a screw such that manufacturing of the velcro inserting type universal synthetic resin mask with a replaceable filter is completed.

### Mode for Carrying out the Invention

In the following, detailed explanations on preferred embodiments of the present invention will be provided by referring to the appended figures. In the explanation on the present invention in the following, detailed explanations on a related known function or a configuration will be omitted when it is determined that they will unnecessarily obscure the subject matter of the present invention.

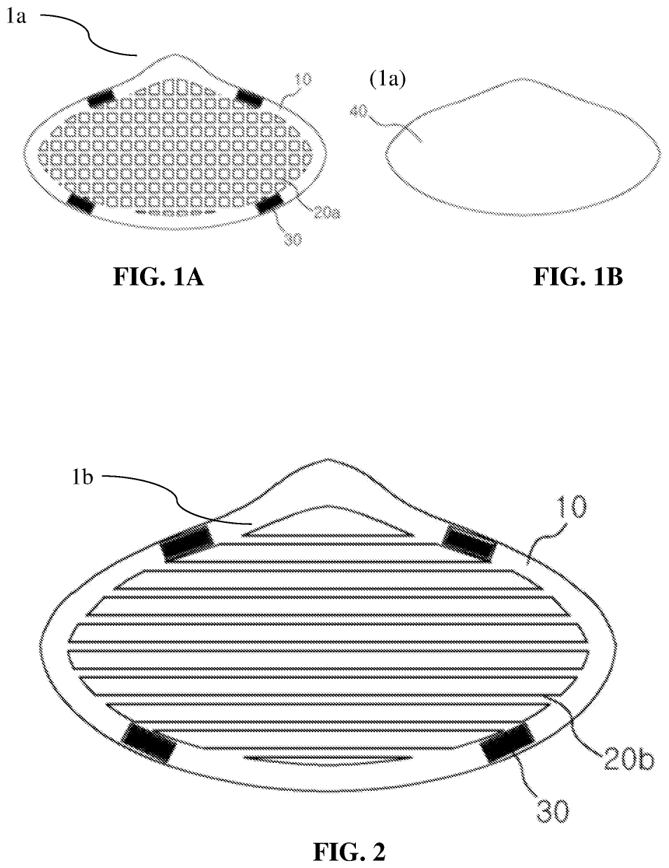

FIGS. 1A and 1B are diagrams illustrating a velcro inserting type universal synthetic resin mask with a replaceable filter 1a which is formed as a first type according to an embodiment of the present invention. The velcro inserting type universal synthetic resin mask with a replaceable filter 1a, which is made as the first type, includes a mask guide 10, a first type filter insertion portion 20a, a velcro for attachment of a filter 30, and a replaceable filter 40.

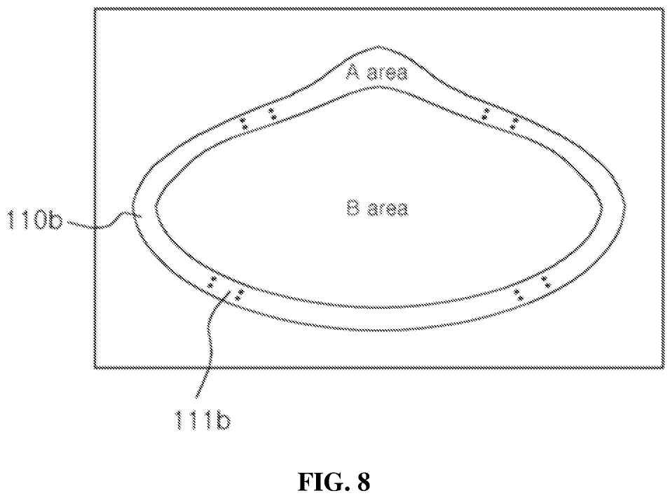

At first, the mask guide 10 has a rim-like shape and supports the first type filter insertion portion 20a therein. The mask guide 10 is formed of a synthetic resin in one entity with the first type filter insertion portion 20a by using an injection molding method using an upper mold (100b, refer to FIG. 8) and a lower mold (100a, refer to FIG. 7).

And, the first type filter insertion portion 20a is formed such that grid patterned rectangular holes are arranged in an inner circumferential surface of the mask guide 10. Here, as shown in FIGS. 1A and 1B, in the first type filter insertion portion 20a, triangular shaped or trapezoidal shaped holes can be arranged in a region adjacent to the mask guide 10 due to the shape of the inner surface of the mask guide 10.

During the injection molding process with respect to the mask guide 10 and the first type filter insertion portion 20a, the velcro for attachment of a filter 30 is placed in front of a velcro entity for attachment of a filter forming portion 111a of the lower mold 100a, and inserted to be fixed on the mask guide 10 through a velcro entity insertion hole forming portion (111b, refer to FIG. 8) of the upper mold 100b. That is, the velcro for attachment of a filter 30 is coupled with and formed on the mask guide 10 by a one-stop injection molding process, which provides an effect of reducing manufacturing time.

The replaceable filter 40 is formed to be attached to and removed from the first type filter insertion portion 20a within the mask guide 10. Here, attachment and removal of the replaceable filter 40 is performed by using the velcro for attachment of a filter 30.

Meanwhile, the replaceable filter 40 provides a replaceable structure of the velcro inserting type universal synthetic resin mask with a replaceable filter 1a 25 consisting of the mask guide 10 and the first type filter insertion portion 20a, thereby enabling the mask to be reused after a long time storage and increasing a hygiene level of the filter by enabling insertion and replacement of the filter.

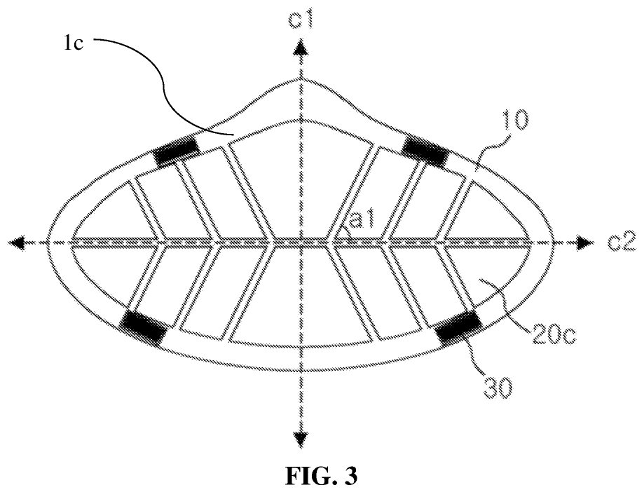

FIG. 2 is a diagram illustrating a velcro inserting type universal synthetic resin mask with a replaceable filter 1b which is formed as a second type according to an embodiment of the present invention. When referring to FIG. 2, the velcro inserting type universal synthetic resin mask with a replaceable filter 1b formed as the second type has the same configuration as the velcro inserting type universal synthetic resin mask with a replaceable filter 1a formed as the first type shown in FIGS. 1A and 1B except in that, the first type filter insertion portion 20a of the velcro inserting type universal synthetic resin mask with a replaceable filter 1a is varied to the shape of a second type filter insertion portion 20b.

Here, the second type filter insertion portion 20b is shown as a set of straight bar shapes which are arranged in a traverse direction. As shown in FIG. 2, it is preferred that the bars are formed to be apart from each other by a uniform spacing.

Meanwhile, manufacturing processes, features, and advantages of the velcro inserting type universal synthetic resin mask with a replaceable filter 1b, 1c, 10 1d, 1e, if formed as the second type as well as the third to sixth type as in the following, as well as the method of attaching and removing the replaceable filter 40 are the same as those for the velcro inserting type universal synthetic resin mask with a replaceable filter 1a formed as the first type and, therefore, duplicate explanations will be omitted in the following.

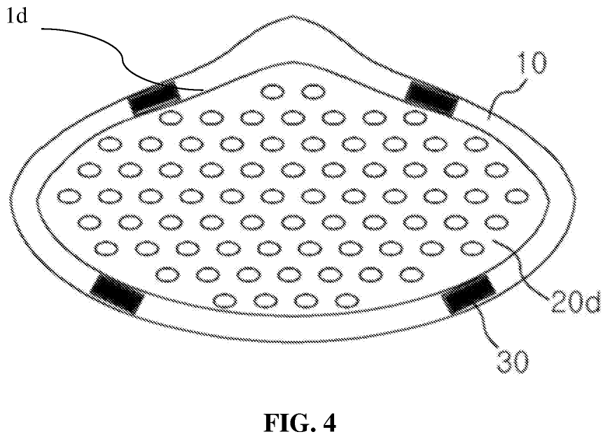

FIG. 3 is a diagram illustrating a velcro inserting type universal synthetic resin mask with a replaceable filter 1c which is formed as a third type according to an embodiment of the present invention. When referring to FIG. 3, the velcro inserting type universal synthetic resin mask with a replaceable filter 1c formed as the third type has the same configuration as the velcro inserting type universal synthetic resin mask with a replaceable filter 1a formed as the first type shown in FIGS. 1A and 1B except in that, the first type filter insertion portion 20a of the velcro inserting type universal synthetic resin mask with a replaceable filter 1a is varied to the shape of a third type filter insertion portion 20c.

Here, the third type filter insertion portion 20c is shown to be formed in a vein pattern of a leaf in both directions from a center line c1 in the length direction.

In this case, six straight line shapes are formed upwards and downwards, respectively, with a preset angle al from a center line c2 in a horizontal direction, and, when these straight line shapes are formed, they are formed to be bilaterally symmetrical with respect to a center line c1 in a length direction. Here the supporting force with respect to the replaceable filter 40 will be maximized when the preset angle al is set at 80-82°.

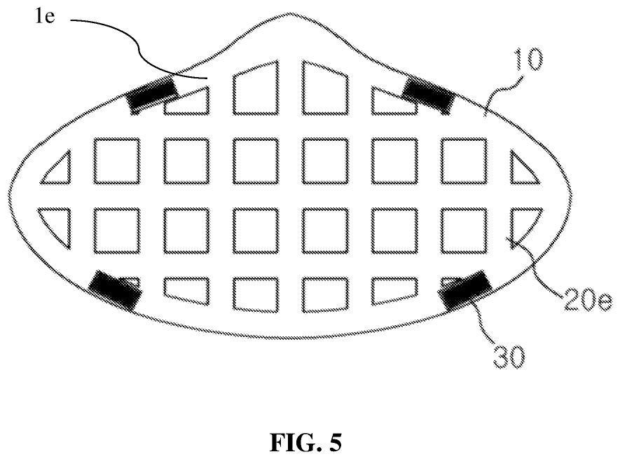

FIG. 4 is a diagram illustrating a velcro inserting type universal synthetic resin mask with a replaceable filter 1d which is formed as a fourth type according to an embodiment of the present invention.

When referring to FIG. 4, the velcro inserting type universal synthetic resin mask with a replaceable filter 1d formed as the fourth type has the same configuration as the velcro inserting type universal synthetic resin mask with a replaceable filter 1a formed as the first type shown in FIGS. 1A and 1B except in that, the first type filter insertion portion 20a of the velcro inserting type universal synthetic resin mask with a replaceable filter 1a is varied to the shape of a fourth type filter insertion portion 20d.

Here, the fourth type filter insertion portion 20d is formed such that grid patterned elliptic holes are arranged in an inner circumferential surface of the mask guide 10.

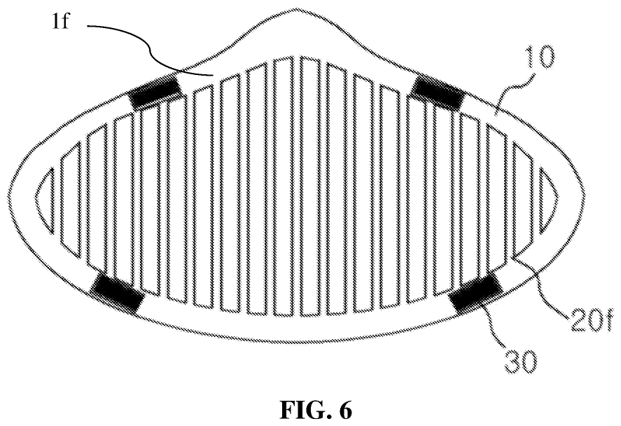

FIG. 5 is a diagram illustrating a velcro inserting type universal synthetic resin mask with a replaceable filter 1e which is formed as a fifth type according to an embodiment of the present invention. When referring to FIG. 5, the velcro inserting type universal synthetic resin mask with a replaceable filter 1e formed as the fifth type has the same configuration as the velcro inserting type universal synthetic resin mask with a replaceable filter 1a formed as the first type shown in FIGS. 1A and 1B except in that, the first type filter insertion portion 20a of the velcro inserting type universal synthetic resin mask with a replaceable filter 1a is varied to the shape of a fifth type filter insertion portion 20e.

Here, the fifth type filter insertion portion 20e is formed in a shape where grid patterned rectangular holes which are bigger than the first type filter insertion portion 20a are arranged in an inner circumferential surface of the mask guide 10. Here, as shown in FIG. 5, triangular shaped or trapezoidal shaped holes can be arranged in a region adjacent to the mask guide 10 due to the shape of the inner surface of the mask guide 10.

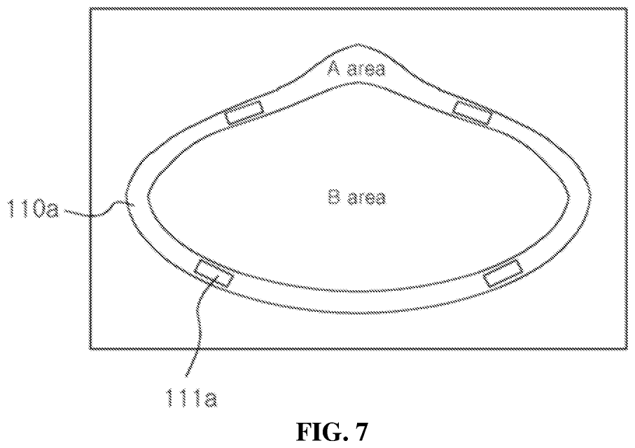

FIG. 6 is a diagram illustrating a velcro inserting type universal synthetic resin mask with a replaceable filter if which is formed as a sixth type according to an embodiment of the present invention. When referring to FIG. 6, the velcro inserting type universal synthetic resin mask with a replaceable filter if formed as the sixth type has the same configuration as the velcro inserting type universal synthetic resin mask with a replaceable filter 1a formed as the first type shown in FIGS. 1A and 1B except in that, the first type filter insertion portion 20a of the velcro inserting type universal synthetic resin mask with a replaceable filter 1a is varied to the shape of a sixth type filter insertion portion 20f.

Here, the sixth type filter insertion portion 20e is shown as a set of straight bar shapes which are arranged in a longitudinal direction. As shown in FIG. 6, it is preferred that the bars in the longitudinal direction are formed to be apart from each other by a uniform spacing.

FIGS. 7 and 8 are diagrams illustrating an injection molding apparatus for the velcro inserting type universal synthetic resin mask with a replaceable filter according to an embodiment of the present invention. At first, FIG. 7 illustrates a lower mold 100a of the insertion molding apparatus for the velcro inserting type universal synthetic resin mask with a replaceable filter, while FIG. 8 is a diagram illustrating an upper mold 100b of the insertion molding apparatus for the velcro inserting type universal synthetic resin mask with a replaceable filter.

The lower mold 100a includes a lower mask guide forming portion 110a and a velcro entity for attachment of a filter forming portion 111a. The lower mask guide forming portion 110a is engraved to form a lower surface of the mask guide 10 as described in the above, and separately includes four velcro entity for attachment of a filter forming portions 111a, on which the velcro for attachment of a filter is placed, at the lower surface of the mask guide 10 in top-down and bilateral symmetry.

Meanwhile, although not shown in the figure, it is preferred that along with an A area where the lower mask guide forming portion 110a of the lower mold 100a is formed, there is provided a B area, where the shapes of the first to sixth types of filter insertion portion 20a-20e as explained in the above are engraved, inside the lower mask guide forming portion 110a.

The upper mold 100b includes an upper mask guide forming portion 110b and a velcro entity insertion hole forming portion 111b.

The upper mask guide forming portion 110b is engraved to form an upper surface of the mask guide 10 as described in the above, and separately includes four velcro entity insertion hole forming portions 111b, on which the velcro for attachment of a filter 30 is placed, at the lower surface of the mask guide 10 in top-down and bilateral symmetry. Here each of the velcro entity insertion hole forming portions 111b is preferably formed as four bulging needles.

Meanwhile, although not shown in the figure, it is preferred that along with an A area where the upper mask guide forming portion 110b of the upper mold 100b is formed, there is provided a B area, where the shapes of the first to sixth types of filter insertion portion 20a-20e as explained in the above are engraved, inside the upper mask guide forming portion 110b.

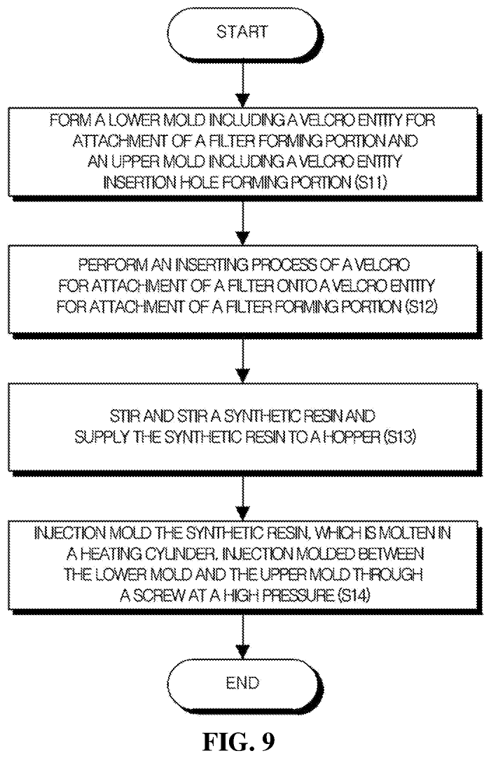

FIG. 9 is a flow chart illustrating a method of manufacturing the velcro inserting type universal synthetic resin mask with a replaceable filter according to an embodiment of the present invention. When referring to FIG. 9, a lower mold 100a including a velcro entity for attachment of a filter forming portion 111a and an upper mold 100b including a velcro entity insertion hole forming portion 111b are formed (S11).

After S11, an inserting process of a velcro for attachment of a filter 30 onto a velcro entity for attachment of a filter forming portion 111a of the lower mold 100a is performed (S12).

After S12, a synthetic resin which is used to form a mask guide 10 as well as the first to sixth type filter insertion portions 20a-20f are stirred and supplied to 20 a hopper (S13).

After step S13, the synthetic resin, which is molten in a heating cylinder, is injection molded between the lower mold 100a and the upper mold 100b through a screw at a high pressure, such that the manufacturing process of the velcro inserting type universal synthetic resin mask with a replaceable filter is completed (S14).

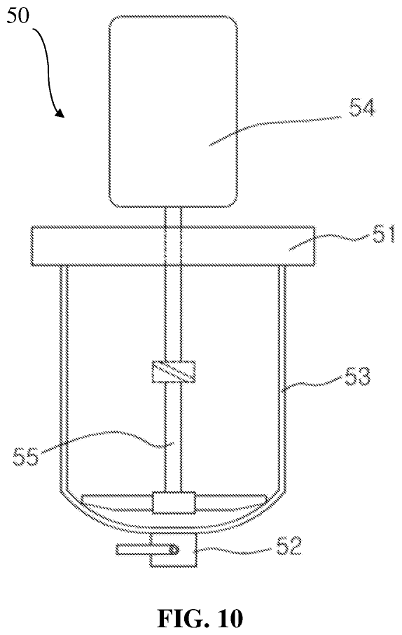

Meanwhile, although not shown in FIG. 9, during S13 in which the synthetic resin is stirred and supplied to the hopper, liquid functional additives such as loess, ceramic, charcoal, etc. can be uniformly mixed with the synthetic resin and to be injected. In this case, a first stirrer for stirring the synthetic resin and a second stirrer, which is formed downstream of the first stirrer and stirs the synthetic resin with the functional additive, can be formed. Structures 50 of the first stirrer and the second stirrer can be the same as the structure shown in FIG. 10. That is, the structure includes a stirring tank 53 having an opened top portion covered enclosed with a cover 51 placed thereon and a bottom portion with a discharge hole 52 formed therein, a driving motor 54 which is provided on the cover 51 of the stirring tank 53 and has a rotation shaft penetrating the cover 51, and a stirring vane 55 which is spline-connected with the rotation shaft of the driving motor 54 which penetrates the cover 51 and rotates.

As explained in the above, although preferred embodiments of the present invention are disclosed and specific terminologies are used in the present application and figures, it will be noted that they are provided only to facilitate the explanation on the subject matter of the present invention and used in general meanings to help readers understand the present invention, and they are not provided to restrict the scope of the present invention. It will be apparent to a person having ordinary skill in the art to which the present invention pertains that, along with the embodiments disclosed in this specification, various modifications based on the technical principle of the present invention can be practiced.

### NUMERICAL SYMBOLS

1a to 1f: velcro inserting type universal synthetic resin masks with a replaceable filter formed as first to sixth types
10: mask guide 20
20a to 20f: first to sixth type filter insertion portions
30: velcro for attachment of a filter
40: replaceable filter
100a: lower mold
110a: lower mask guide forming portion 25
111a: velcro entity for attachment of a filter forming portion
100b: upper mold
110b: upper mask guide forming portion
111b: velcro entity insertion hole forming portion

1. An injection molding apparatus for a velcro inserting type mask with a replaceable filter, the apparatus comprising:
a lower mold which is engraved to form a lower side of a mask guide which constitutes the velcro inserting type mask with the replaceable filter, wherein the lower mold includes a lower mask guide forming portion including a plurality of separate velcro entities for attachment of a filter forming portion for placing a velcro for attachment of a filter on a lower surface of the mask guide, wherein the velcro entities for attachment of the filter forming portion are arranged in top-down and bilateral symmetry; and
an upper mold which is engraved to form an upper side of the mask guide, wherein the upper mold includes an upper mask guide forming portion including a plurality of separate velcro entity insertion hole forming portions for fixing the velcro for attachment of the filter on a lower surface of the mask guide, wherein the velcro entity insertion hole forming portions are arranged in top-down and bilateral symmetry.

2. The injection molding apparatus of claim 1, wherein each of the velcro entity insertion hole forming portions comprises a plurality of bulging needles.

3. The injection molding apparatus of claim 1, further comprising:
a first stirrer and a second stirrer for stirring a predetermined material for forming the mask guide and the filter insertion portion and, when the stirred predetermined material is supplied to a hopper, mixing and stirring the predetermined material with liquid functional additives uniformly such that they are supplied to the hopper together, respectively,
wherein the first stirrer stirs the predetermined material, and
wherein the second stirrer is formed downstream of the first stirrer and formed to stir the predetermined material with the functional additives and supply the stirred material to the hopper.

4. The injection molding apparatus of claim 3, wherein each of the first stirrer and the second stirrer comprises:
a stirring tank with an opened top portion, wherein a cover is provided to enclose the opened top portion and a discharge hole is formed in a bottom portion of the stirring tank;
a driving motor which is provided on the cover of the stirring tank, wherein a rotation shaft of the driving motor penetrates the cover; and
a stirring vane which is spline-coupled with the rotation shaft of the driving motor, which penetrates the cover, and rotates.
